(19) United States
(12) Patent Application Publication
(10) Pub. No.: US 2006/0226280 A1
(43) Pub. Date: Oct. 12, 2006

(54) Stowable design for unmanned aerial vehicle

(76) Inventor: James Alman, St. Petersburg, FL (US)

Correspondence Address: DUNLAP, CODDING & ROGERS P.C., PO BOX 16370, OKLAHOMA CITY, OK, 73113, US

(21) Appl. No.: 11/305,524

(22) Filed: Dec. 16, 2005

Related U.S. Application Data
(60) Provisional application No. 60/637,481, filed on Dec. 17, 2004.

(51) Int. Cl. B64C 1/00; B64C 3/00

(52) U.S. Cl. 244/13; 244/903

(57) ABSTRACT

An unmanned aerial vehicle (UAV) having a design for optimum stowability and low cost. The UAV having a collapsible wing section which can be easily removed from the fuselage, allowing for quick assembly and disassembly and ease of portability. The unmanned aerial vehicle includes a primary wing assembly, a fuselage, a means for propelling the unmanned aerial vehicle, and means for remotely controlling the unmanned aerial vehicle. The primary wing assembly includes a wing having a center spar and two outwardly diverging side spars. The wing also has a pliable flexible material supported by the center spar and the at least two outwardly diverging side spars. The pylon is connected to the wing and supports the wing. The fuselage is connected to the pylon such that the pylon extends away from the fuselage and spaces the wing a distance from the fuselage. The fuselage includes a tail having a rudder located along a trailing edge and elevators located along the trailing edge.

### CROSS REFERENCE TO RELATED APPLICATIONS

The present application claims priority to the provisional patent application identified by U.S. Ser. No. 60/637,481, filed on Dec. 17, 2004, the entire content of which is hereby incorporated herein by reference.

### STATEMENT REGARDING FEDERALLY SPONSORED RESEARCH OR DEVELOPMENT

Not applicable.

### BACKGROUND OF THE INVENTION

1. Field of the Invention

This invention relates to a design for an unmanned aerial vehicle (UAV). More particularly, the present invention relates to a UAV which can be quickly and easily disassembled, stowed and transported.

2. Prior Art

Use of unmanned aerial vehicles (UAVs), also commonly referred to as drones or remotely piloted vehicles (RPVs), are well known in the art. They provide a platform from which aerial surveillance can be performed. Likewise, they can be used to deliver small munitions. While these tasks can be performed by manned aircraft, the UAVs provide the benefit of lower cost per unit and lower operating costs than a manned aircraft.

UAVs also help protect human life. When a UAV enters hostile territory, the operator of the UAV is not in any personal danger, only the craft itself can be lost.

While the use of UAVs is well established, there is a growing need for them in military applications. One of the primary attributes that is looked at in selection of a UAV is that it can be easily assembled and disassembled and readily transportable for ease of deployment.

U.S. Pat. No. 5,035,382, entitled “Rapid Assembly Aircraft for Ground Surveillance,” issued to Lissaman et al., on Jul. 30, 1991. The Lissaman patent discloses an unmanned aircraft which can be readily disassembled into components which can be easily transported.

U.S. Pat. No. 5,118,062, entitled “Variable Geometry RPV,” issued to Alvarez Caldaron on Jun. 2, 1992. The Caldaron patent discloses a remotely piloted vehicle with solid wings. The wings and tail can be rotated so that they are parallel with the fuselage for ease of transportation or shipping.

One of the drawbacks of the UAVs shown in Lissaman and Caldaron is that the wings are made of a solid material. This makes them more susceptible to damage in assembly, disassembly and shipping. This also makes them harder to repair should they be damaged. Yet another drawback of the solid wing configuration is the cost in fabricating. The solid wing configuration also has the drawback of being bulkier, thus requiring more space when disassembled.

### SUMMARY OF THE INVENTION

Due to the shortcomings of the prior art, it is an objective of the present invention to provide a UAV which can be rapidly assembled and disassembled.

Another objective of the present invention is to provide a UAV whose design is durable to withstand damage incurred in assembling, disassembling and shipping.

It is a further objective of the present invention to provide a UAV which can be easily repaired in the event of damage.

It is yet another objective of the present invention to provide a UAV which is more inexpensive to manufacture than the prior art.

Still another objective of the present invention is to provide a UAV that is lightweight and easily deployable.

It is to be understood that both the foregoing general description and the following detailed description are exemplary and explanatory only, and are not restrictive of the invention as claimed. The accompanying drawings, which are incorporated herein by reference, and which constitute a part of this specification, illustrate certain embodiments of the invention, and together with the detailed description, serve to explain the principles of the present invention.

In this respect, before explaining at least one embodiment of the invention in detail, it is to be understood that the invention is not limited in this application to the details of construction and to the arrangement of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the design engineers and practitioners in the art who are not familiar with patent or legal forms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### DESCRIPTION OF THE DRAWINGS

FIG. 1 is a side view of one embodiment of the present invention.

FIG. 2 is a top view of one embodiment of the present invention.

FIG. 3 is a front view of one embodiment of the present invention.

FIG. 4 is a bottom view of the wing assembly.

FIG. 5 is a close up sectional view of one embodiment of a pylon's attachments to a center spar and cross spars.

### DETAILED DESCRIPTION OF THE INVENTION

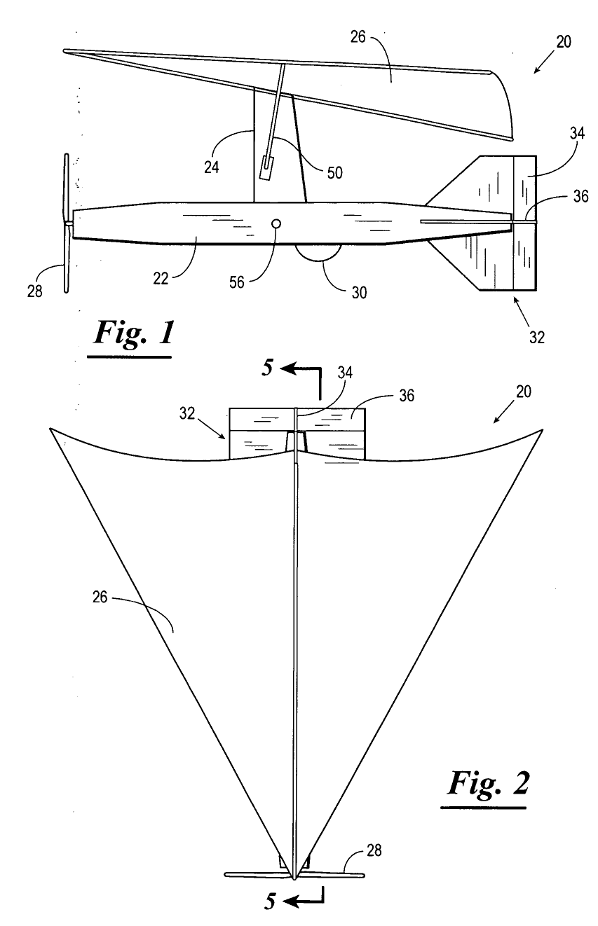

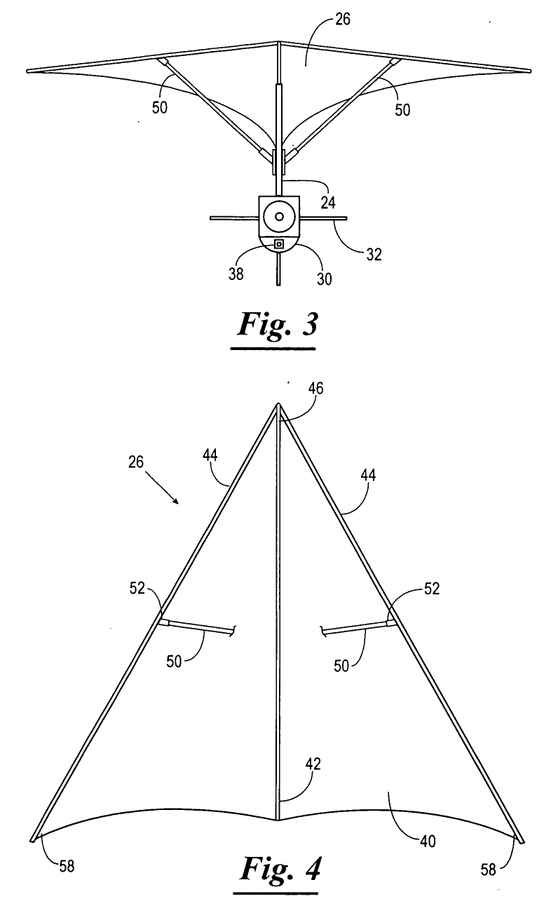

FIG. 1 shows a side view of a UAV 20 of the present invention. FIGS. 2 and 3 show a top view and a front view respectively of the UAV 20 of the present invention. The UAV 20 has a fuselage 22 with a pylon 24. The pylon 24 and wing 26 are removably attached to the fuselage 22 by a nylon bolt 56. The fuselage 22 also has a propeller 28, a camera pod 30 and a tail 32. The tail 32 typically has a rudder 34 located along the trailing edge 58 as well as elevators 36 also located along the trailing edge.

The propeller 28 is rotated by an electric motor powered by batteries in the preferred embodiment. However, the propeller 28 could also be powered by a small combustion engine.

The camera pod 30 contains a camera 38 which could be capable of capturing either still and/or moving pictures. Likewise, the camera 38 could also be fixed in one direction relative to the fuselage 22 or be capable of being reoriented relative to the fuselage 22 while the UAV 20 is in flight.

In other embodiments of the present invention the camera pod 30 might be replaced with small armaments or munitions. FIG. 4 shows the underside of the wing 26. The wing 26 is made of a soft, flexible fabric or other composite material 40, which is fastened to a center spar 42 and at least two or more side spars 44, located on either side of the center spar 42. The side spars 44 are hingedly attached to the nose end 46 of the center spar 42.

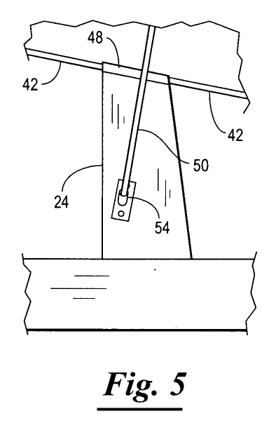

In the preferred embodiment shown in FIG. 5, there is a sleeve 48 attached to the top of the pylon 24. The center spar 42 slides through the sleeve 48. The wing assembly 26 has two cross spars 50. The cross spars 50 are flexibly attached to the side spars 44 at a location approximately identified as 52. The opposite end of the cross spars 50 are attached to the pylon 24 when the wing assembly 26 is erected. The preferred embodiment of the attachment of the cross spars 50 to the pylon 24 are shown in FIG. 5. In the preferred embodiment there is a rod 54 which extends from the pylon 24 toward the cross spar's 50 attachment 52 to the side spar 44. In the preferred embodiment, the cross spars 50 are hollow. However, spars with different cross sectional configurations can be used. When the wing 26 is erected the rod 54 extends into the cross spar 50.

A portion of the pylon 24 extends in the fuselage 22. The two are secured together by a screw 56 which passes through the fuselage 22 and pylon 24. Thus, in order to remove the wing assembly 26 and pylon 24 from the fuselage 22, the screw 56 is removed. The wing assembly 26 and pylon 24 can be lifted away from the fuselage 22. The wing assembly 26 can be removed from the pylon 24 by separating the cross spars from the rods 54 and sliding the center spar 42 out of the sleeve 48. The wing assembly 26 can then be folded by rotating the cross spars 50 so they are approximately parallel with the side spars 44. The side spars 44 are then moved so they are approximately parallel with the center spar 42. The components of the entire UAV 22 can then be stowed in a case or cylindrical tube. The UAV 22 can then be assembled for deployment by reversing the steps outlined above for stowing the UAV 22.

When the UAV 20 of the present invention is in use, it is anticipated that it would be controlled by a remote user using radio frequency controls, also referred to as RF controls, which are typically known in the art. The operation of the camera 38, armaments or munitions could also be controlled by the same means.

While this invention has been described to illustrate embodiments, this description is not to be construed in a limiting sense. Various modifications and combinations of the illustrative embodiments, such as joints between components, as well as other embodiments, will be apparent to those skilled in the art upon referencing this disclosure. It is therefore intended that this disclosure encompasses any such modification or embodiments.

| | |
|---|---|
| 20 | UAV |
| 22 | Fuselage |
| 24 | Pylon |
| 26 | Collapsible wing |
| 28 | Propeller |
| 30 | Camera pod |
| 32 | Tail |
| 34 | Rudders |
| 36 | Elevators |
| 38 | Camera |
| 40 | Fabric/composite |
| 42 | Center spar |
| 44 | Side spar |
| 46 | Nose end (of center spar) |
| 48 | Sleeve |
| 50 | Cross spars |
| 52 | Cross spar's hinged attachment to side spars |
| 54 | Rod |
| 56 | Screw |
| 58 | Trailing edge |

What is claimed is:

1. An aerial vehicle, comprising:
a primary wing assembly comprising:
a wing having a center spar and two outwardly diverging side spars, the wing also having a pliable flexible material supported by the center spar and the at least two outwardly diverging side spars;
a pylon connected to the wing and supporting the wing;
a fuselage connected to the pylon such that the pylon extends away from the fuselage and spaces the wing a distance from the fuselage, the fuselage comprising:
a tail having a rudder located along a trailing edge and elevators located along the trailing edge;
means for propelling the aerial vehicle; and
means for remotely controlling the aerial vehicle.

2. The aerial vehicle of claim 1, further comprising a camera pod containing a camera.

3. The aerial vehicle of claim 1, wherein the pliable flexible material is fastened to the center spar and to the at least two side spars.

4. The aerial vehicle of claim 1, wherein the center spar has a nose end, and wherein the at least two side spars are attached to the nose end of the center spar.

5. The aerial vehicle of claim 4, wherein the at least two side spars are hingedly attached to the nose end of the center spar.

6. The aerial vehicle of claim 1, wherein the wing assembly further comprises a sleeve attached to the top of the pylon, and wherein the center spar is positioned through the sleeve.

7. The aerial vehicle of claim 6, wherein the center spar slides through the sleeve.

8. The aerial vehicle of claim 7, wherein the wing assembly further comprises at least two cross spars with the cross spars extending between the pylon and respective side spars.

9. The aerial vehicle of claim 1, wherein the wing assembly further comprises at least two rods with each rod mounted on the pylon.

10. The aerial vehicle of claim 9, wherein at least one of the rods extends into one of the cross spars.

11. The aerial vehicle of claim 1, wherein the aerial vehicle is characterized as an unmanned aerial vehicle.

12. A method for disassembling an unmanned aerial vehicle having a pylon connected to a fuselage with the pylon supporting a wing assembly a distance away from the fuselage, the wing assembly having a center spar, cross spars and side spars, comprising the steps of:
removing the pylon from the fuselage;
removing the wing assembly from the pylon; and
folding the cross spars and side spars to be substantially parallel with the center spar.

13. The method of claim 12, wherein the step of removing the pylon from the fuselage is defined further as removing a screw which passes through the fuselage and pylon, and lifting the pylon away from the fuselage.

14. The method of claims 12, wherein the step of removing the wing assembly from the pylon is defined further as separating the cross spars from rods connected to the pylon.

15. The method of claim 12, wherein the step of removing the wing assembly from the pylon is defined further as sliding the center spar out of a sleeve.

16. The method of claim 12, further comprising the step of stowing the components of the unmanned aerial vehicle in a case.

17. The method of claim 12, further comprising the step of stowing the components of the unmanned aerial vehicle in a cylindrical tube.
